(19) United States
(12) Patent Application Publication
(10) Pub. No.: US 2026/0169845 A1
(43) Pub. Date: Jun. 18, 2026

(54) ANALYSIS OF COMPUTER ERROR CODES FOR PREEMPTIVE COLLECTION OF DEBUGGING DATA

(71) Applicant: International Business Machines Corporation, Armonk, NY (US)

(72) Inventors: David Michael WALTERS, Manahawkin, NJ (US); Stephanie Carys SHUM, Wappingers Falls, NY (US); Patrick John CLAS, Pine Plains, NY (US); David JUN, Nanuet, NY (US)

(21) Appl. No.: 18/981,526

(22) Filed: Dec. 14, 2024

(51) Int. Cl. G06F 11/07

(52) U.S. Cl. CPC G06F 11/0781; G06F 11/079; G06F 11/0793

(57) ABSTRACT

A component may obtain current error data during a current analysis time window. The current error data may include current error codes indicating an error associated with a computing device. The component may determine measures of similarity between the current error data of the current analysis time window and historical error data of historical analysis time window. The historical error data may include historical error codes. The component may determine a measure of similarity, associated with a historical analysis time window of the historical analysis time windows, that satisfies a value threshold; and predict, based on the historical analysis time window, whether an additional error code is expected to be provided during the current analysis time window. The component may obtain debugging data based on predicting whether the additional error code is expected to be provided.

### BACKGROUND

The present invention relates to computer error analysis, and for example, relates to preemptive collection of debugging data to correct computer error.

In the rapidly evolving landscape of computer systems and networks, error management and analysis have become increasingly important components of maintaining operational efficiency and reliability of computer systems and networks. As computing environments become more complex, with distributed systems, cloud architectures, and interconnected devices, the volume and variety of computer errors that can occur have expanded exponentially. Managing and correcting the volume and variety of computer errors is a complex and time consuming task.

### SUMMARY

A method, comprising: obtaining, from a computing device, current error data during a current analysis time window, wherein the current error data includes current error codes indicating an error associated with the computing device; determining Jaccard indexes based on the current error data and historical error data of historical analysis time windows, wherein the historical error data includes historical error codes, wherein the Jaccard indexes indicates a measure of similarity between the current error data of the current analysis time window and the historical error data of the historical analysis time window; determining a Jaccard index, associated with a historical analysis time window of the historical analysis time windows, that satisfies a value threshold; predicting, using a Markov chain applied to the historical analysis time window, whether an additional error code is expected to be provided during the current analysis time window, wherein a priority assigned to the additional error code exceeds priorities assigned to the current error codes; and obtaining debugging data, associated with the additional error code or one of the current error codes, during the current analysis time window based on predicting whether the additional error code is expected to be provided during the current analysis time window, wherein the debugging data includes data for correcting the error.

A computer system may comprise: a storage device; and a processor set; one or more computer-readable storage media; and program instructions stored on the one or more computer-readable storage media to cause the processor set to perform operations comprising: obtaining current error data during a current analysis time window, wherein the current error data includes current error codes indicating an error associated with a computing device; determining measures of similarity between the current error data of the current analysis time window and historical error data of historical analysis time window, wherein the historical error data includes historical error codes; determining a measure of similarity, associated with a historical analysis time window of the historical analysis time windows, that satisfies a value threshold; predicting, based on the historical analysis time window, whether an additional error code is expected to be provided during the current analysis time window; obtaining debugging data, associated with the additional error code or one of the current error codes, during the current analysis time window based on predicting that the additional error code is expected to be provided during the current analysis time window; and causing the error of the computing device to be corrected based on the debugging data.

A computer program product may comprise: one or more computer-readable storage media; and program instructions stored on the one or more computer readable storage media to perform operations comprising: obtaining current error data during a current analysis time window, wherein the current error data includes current error codes indicating an error associated with a computing device; determining measures of similarity between the current error data of the current analysis time window and historical error data of historical analysis time window, wherein the historical error data includes historical error codes; determining a measure of similarity, associated with a historical analysis time window of the historical analysis time windows, that satisfies a value threshold; predicting, based on the historical analysis time window, whether an additional error code is expected to be provided during the current analysis time window; and obtaining debugging data, associated with the additional error code or one of the current error codes, based on predicting whether the additional error code is expected to be provided during the current analysis time window, wherein the additional error code or the one of the current error codes is indicative a root cause of the error.

### BRIEF DESCRIPTION OF THE DRAWINGS

FIG. 1 illustrates a block diagram of a computing environment described herein.

FIGS. 2A-2G are diagrams of an example implementation described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with obtaining debugging data for correcting a computer error.

### DETAILED DESCRIPTION

The following detailed description of example implementations refers to the accompanying drawings. The same reference numbers in different drawings may identify the same or similar elements.

Computer error analysis may be performed in single finite timing windows (or problem analysis windows). Depending on a type of a computer error, error codes may be grouped and analyzed within a current problem analysis window to determine a singular root cause of the computer error. The computer error may be caused by a component of a computer (e.g., a hardware component and/or a software component). The error codes may be generated by firmware of the computer as a result of the firmware detecting the computer error in the computer.

In some situations, a problem analysis window may be initiated for collecting the error codes (e.g., after one or more of the error codes initially occur). After the problem analysis window closes, the error codes may be analyzed to determine the singular root cause of the computer error. After the singular root cause has been analyzed, additional data regarding the singular root cause may be collected from other components of the computer. The additional data may include files, logs, among other examples of information that may be relevant to the computer error and may be used to correct the computer error.

Because the error codes are grouped and analyzed within a problem analysis window, the collection of the additional data can only occur after the problem analysis window is completed (e.g., closed) and the computer error is fully determined (e.g., properly identified). In this regard, the additional data may be collected a considerable amount of time after the computer error occurs. Accordingly, the additional data may become obsolete (e.g., irrelevant) because the computer error may have been corrected during the problem analysis window or after the problem analysis window is completed (or closed).

In some situations, the additional data may not be timely collected from multiple additional computers in a network that includes the computer. For example, the additional computers may may shutdown and become unavailable to provide the additional data. In other words, the additional computers may lose power before the additional data is collected. Another example of not collecting the additional data may occur due to loss of communication with the other computers. In other words, the additional computers may lose connectivity to the network before the additional data is collected. For example, a primary computer may lose communication with an alternate computer before the problem analysis window is completed on the alternate computer. The primary computer may be used as a main instance of mainframe management for a singular mainframe. The alternate computer may exist for redundancy. In this regard, if the primary computer become unavailable (e.g., due to loss of power, corrupted storage, etc.), the alternate computer may provide redundancy with respect to the primary computer.

As a result of the foregoing, defect turnaround times increase as the additional data (for addressing the computer errors) is missing, which causes a support representative to fetch the additional data manually using a computing device. The defect turnaround times may refer to turnaround times for addressing computer errors. Fetching the additional data using the computing device consumes the computing resources of the computing device, consumes storage resources of the computing device (e.g., used to store the error codes), consumes network resources used by the computing device to communicate with other computing devices. Additionally, because the additional data is irrelevant, collecting the data as described above unnecessarily consumes computing resources (e.g., used to collect the additional data), consumes storage resources (e.g., used to store the additional data), and consumes network resources used to collect the additional data from the computer.

In addition to the foregoing, data (e.g., error codes) of problem analysis windows are analyzed sequentially. In other words, data of a first problem analysis window may be analyzed, data of a second problem analysis window may be analyzed after the first problem analysis window, and so on. Analyzing the data of different problem analysis windows in this manner may cause additional data for later occurring problem analysis windows to become more obsolete (e.g., more irrelevant). Accordingly, collecting the additional data as described above causes multiple technical problems.

Implementations described herein are directed to timely collection of debugging data to correct an error of the computing device. An “error” (or computer error) may be used to refer to an error caused by a component of the computing device. For example, the component may not perform an intended operation of the component. In some situations, the error may cause a failure of the component (and/or of the computing device). In some situations, the error may be caused by a failure of the component. The component may include a hardware component and/or a software component. The debugging data may include files, logs, stack traces, a core dump, among other examples of information that may be relevant to the error and may be used to correct the error.

In some examples, implementations described herein are directed to a technical solution that includes a predictive collection of the debugging data. The collection of the debugging data may be predictive because error codes, relating to the error, may be analyzed to predict when the debugging data is to be collected. Additionally, the collection of the debugging data may be preemptive because the debugging data may be collected (or, in other words, obtained) before the debugging data becomes irrelevant (e.g., obsolete) and/or before the debugging data becomes unavailable.

In some examples, within a current analysis time window, an error analysis component may use historical logs and system information to analyze any additional problems occurring within the current analysis time window and determine a likelihood of the error being reported. The historical logging and system information may refer to data previously collected from the computer or another computer and transmitted (e.g., one or more other computers) for further analysis. The information may be regularly scheduled data transmissions for monitoring system usage. This information may identify past errors causing data to be transmitted for further error analysis. The historical logs and system information may include historical error codes, information regarding historical analysis time windows associated with the historical error codes, error messages, as well as memory usage, memory consumption, network traffic, and other system metrics for deviations from established baselines.

In some examples, the error analysis component may analyze error codes obtained during the current analysis time window to determine the likelihood of the error being reported. The error codes may be included in error data. An “analysis time window” may be used to refer to a window of time and processing resources allocated for obtaining, analyzing, and grouping related error codes. The analysis time window may also be referred to as a problem analysis window.

The error codes (or error reference codes (refcode)) may be assigned different priorities. In some examples, the error code with the highest priority (with the current analysis time window) may indicate a root cause of the error, such as a power failure, a network failure, among other examples. The error code with the highest priority may be reported to a service system to cause the service system to correct the error associated with the error code. For example, the error analysis component may report the error code along with debugging data regarding an error associated with the error code to the service system. In some situations, a priority assigned to an error code may be adjusted. For example, the priority may be adjusted based on information regarding one or more other error codes obtained during a same analysis time window.

In some examples, a Jaccard index is calculated to quantify a similarity between historical error codes within historical analysis time windows and the error codes within the current analysis time window. The historical error codes and information regarding the historical analysis time windows may be included in the historical logging and system information. If the Jaccard index, associated with an additional historical analysis time window, satisfies a value threshold, the error analysis component may use a Markov chain to predict whether higher priority error codes (e.g., higher than already collected error codes) are expected to be obtained (or collected) during the current analysis time window. A “higher priority error code” may refer to an additional error code assigned a higher priority (e.g., a priority that exceeds a priority assigned to other error codes that have already been collected during the current analysis time window).

If the error analysis component predicts that a higher priority error code will not be collected during the current analysis time window, the error analysis component will obtain (or collect) debugging data regarding the error indicated by a current highest priority code. The error analysis component may determine that the error, indicated by the current highest priority error code, is to be reported.

Based on determining that the error is to be reported, the error analysis component may determine that the debugging data, associated with the error indicated by the current highest error code, is to be reported with the error. Accordingly, the error analysis component may determine that the debugging data is to be obtained during the current analysis time window to prevent the possibility of the debugging data becoming irrelevant and/or unavailable. In some situations, if a higher priority error code is obtained after the error analysis component predicts that a higher priority error code will not occur, debugging data for the higher priority error code may be collected. The debugging data for the higher priority error code may be replace the debugging data that has been collected for a previous highest priority code (e.g., the current highest priority error code mentioned above). If the error analysis component predicts that a higher priority error code will be collected during the current analysis time window, then the error analysis component will determine that debugging data (for that highest priority error) is to be collected. In some implementations, the error analysis component will obtain the debugging data (for the higher priority error code) during the current analysis time window before the higher priority error code is obtained. In some implementations, the error analysis component will obtain the debugging data during the current analysis time window after the higher priority error code is obtained.

Based on the foregoing, the error analysis component will initiate a collection of debugging data of a highest priority error code (indicating the root causing problem) during a current problem analysis window in which the highest priority error code was collected. In some examples, the debugging data may include a group of files that are used to analyze a causation and a solution for the error. The current problem analysis window is ongoing while allowing the debugging data (e.g., files to be obtained in parallel) to be obtained as the current problem analysis window is approaching completion. Collecting the debugging data will provide the error analysis component a significantly greater chance of capturing meaningful debugging data closer to when the error occurs. Initiating data collection while the analysis (to determine the root cause) is ongoing also gives the error analysis component more reliability to connect to remote nodes that store the debugging data. For example, initiating data collection may ensure that the error analysis component communicates with the remote nodes before the remote nodes experience communication issues.

In some examples, the error analysis component may cause the error to be corrected based on the error data and/or the debugging data. For example, the error analysis component may analyze the error data and/or the debugging data to determine a corrective action to correct the error. The error analysis component may cause one or more components of the computing device and/or one or more other computing devices to correct the error. In some implementations, the error analysis component may provide the error data and/or the debugging data to a service system (e.g., the one or more other computing devices) to determine and implement the corrective action. In some examples, providing the error data and/or the debugging data to the service system may be referred to as a call home operation.

Based on the foregoing, implementations described herein provide a technical solution that preserve resources that would have been consumed to obtain debugging data that is irrelevant. For example, the technical solution preserves computing resources (e.g., used to collect the debugging data), storage resources (e.g., used to store the debugging data), and consumes network resources used to collect the debugging data. Furthermore, during the current problem analysis window, the error analysis component may scan (or analyze) the error codes to identify historical error codes (e.g., historical high priority error codes) that have been rejected as indicating root cause of other errors.

The error analysis component may analyze the error codes to preemptively filter error codes that are false positive error codes with respect to indicating root problems. By filtering the error codes, implementations described herein may remove the false positive error codes from the current error data and may preserve time associated with utilizing the error codes, preserve computing resources associated with utilizing the error codes, and preserve storage resources associated with utilizing the error codes. By filtering the error codes, implementations described herein may improve an efficiency correcting the error.

While examples herein discuss Jaccard index and Markov chain, other techniques may be used to determine the similarities between error codes and to predict occurrence of high priority codes. For example, implementations herein may utilize different stochastic processes, different statistical probabilities, among other examples.

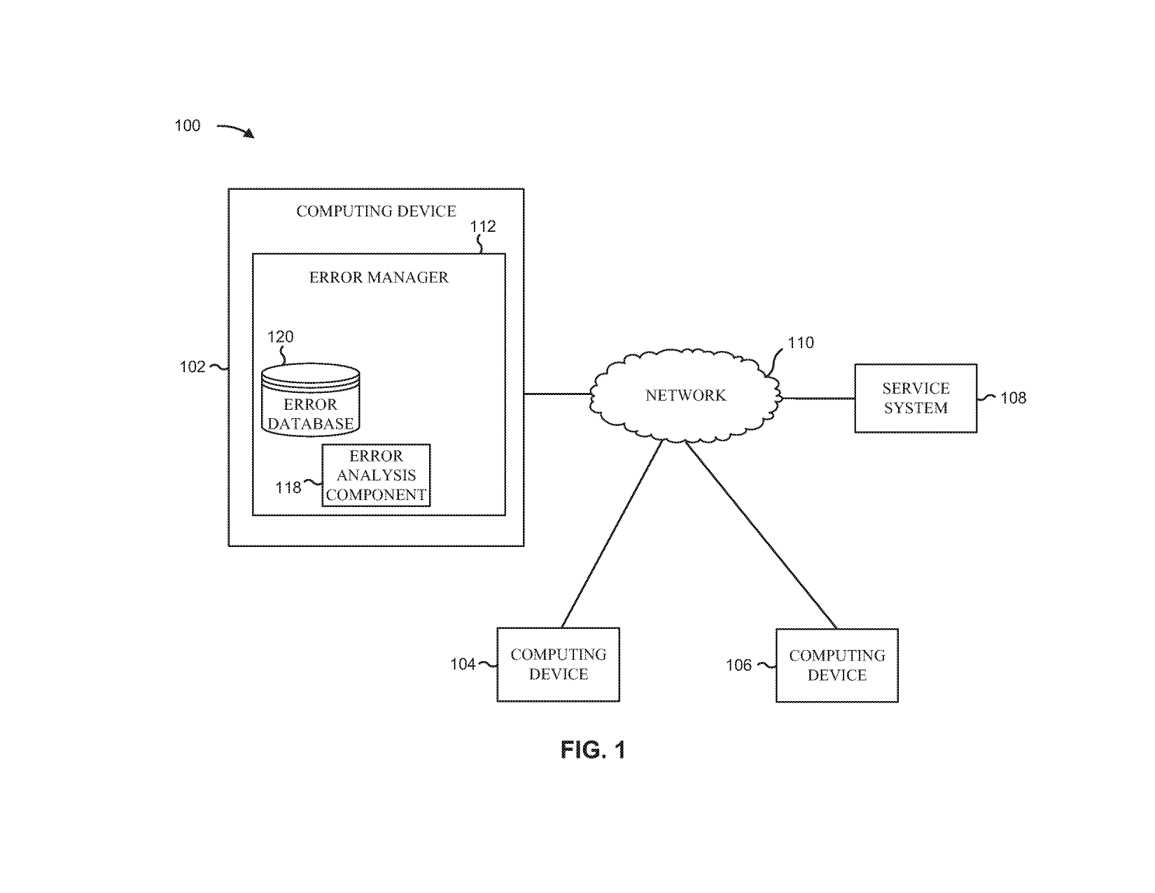

FIG. 1 illustrates a block diagram of a computing environment 100 for managing and analyzing errors. The computing environment 100 includes a computing device 102, additional computing devices 104 and 106, a service system 108, and a network 110 connecting these components.

Any one or more of the computing devices 102, 104, and 106 may encompass a wide range of computing systems and architectures. In some aspects, these devices may be part of a cloud computing infrastructure, which may include public, private, or hybrid cloud environments. Cloud computing devices may include virtualized resources, such as virtual machines or containers, running on physical hardware in data centers. In some implementations, the computing devices 102, 104, and 106 may be based on mainframe architectures. These systems may be designed for high-volume transaction processing and may include features like redundant components for high availability and reliability. Mainframe systems may be particularly suited for handling large-scale error management tasks due to their robust error detection and recovery capabilities.

The computing devices 102, 104, and 106 may include distributed systems, such as those based on microservices architectures. In these systems, applications may be broken down into smaller, independent services that communicate over a network. This architecture may allow for more granular error detection and management at the individual service level. In some implementations, the computing devices 102, 104, and 106 may be edge computing nodes, which process data closer to the source of data generation. These devices may be responsible for initial error detection and triage before communicating with centralized systems for more comprehensive analysis.

These devices may have limited resources but may play a role in detecting and reporting errors at the edge of the network. In some implementations, the computing devices 102, 104, and 106 may include mobile devices, such as smartphones or tablets, which may act as both sources of error data and interfaces for system administrators to monitor, manage, and rectify errors remotely.

The computing device 102 contains an error manager 112, which is responsible for handling and processing errors. The error manager 112 may be implemented as software running on the computing device 102, as a dedicated hardware component, or as a combination of hardware and software. In some embodiments, the error manager 112 may be distributed across multiple devices or implemented as a cloud-based service.

In some implementations, the error manager 112 may detect errors and generate error codes indicating the errors. In some examples, an error code may include four bytes of data or any other amount of data. In some examples, an error code may assign a priority that may be based on a severity of an error indicated by the error code and potential impact on the computing device 102 (and/or on other computing devices connected to the computing device 102). In some situations, one or more other components of the computing device 102 (e.g., hardware, software, and/or firmware) may detect the errors and generate the error codes. The error manager 112 may include subcomponents, such as an error analysis component 118 and an error database 120. These components work together to provide a technical solution for efficient error management, analysis, and correction. In some examples, the error analysis component 118 and the error database 120 may be distributed across multiple devices.

As used herein, an "analysis time window" may refer to a designated portion of a queue or processing resource allocated for analyzing and grouping related errors within a specified time frame. Analysis time windows may be dynamically adjusted in size or duration based on factors such as error frequency, severity, or system load, potentially improving overall error management efficiency.

The error analysis component 118 processes the errors detected. For example, the error analysis component 118 may process error codes to determine a root cause of the error. In some implementations, the error analysis component 118 may use information stored in the error database 120 to assist in the analysis. The error analysis component 118 may employ various analysis techniques, such as pattern recognition, statistical analysis, probabilistic analysis, stochastic analysis, or machine learning algorithms to identify similarities between analysis time windows, identify the root causes of errors, and suggest potential solutions. In some embodiments, the error analysis component 118 may also prioritize errors based on their severity and potential impact on the system.

The error database 120 stores historical information about past analysis time windows, error codes, errors indicated by the error codes, the causes, and resolutions. In some implementations, the error database 120 may include a data store that stores information identifying different errors in association with information regarding different debugging data to be obtained to correct the different errors. The information regarding the different debugging data may identify the debugging data and identify a source of the debugging data (e.g., components of the computing device 102 and/or one or more other computing devices). This database may be implemented using various database technologies, such as relational databases, NoSQL databases, or graph databases, depending on the specific requirements of the system. The error database 120 may facilitate improving the accuracy and efficiency of error analysis over time.

The network 110 may encompass a wide range of communication technologies and architectures to facilitate data exchange between the various components of the computing environment. In some implementations, the network 110 may include traditional wired networks, such as Ethernet-based local area networks (LANs) or fiber optic networks for high-speed, long-distance data transmission. These wired networks may provide reliable, high-bandwidth connections suitable for data-intensive error management tasks. Wireless technologies may also be incorporated into the network 110. For instance, Wi-Fi networks may enable flexible connectivity within office environments or data centers, while cellular networks, including 4G LTE or 5G, may support mobile devices or remote sensors in IoT scenarios. In some cases, the network 110 may leverage satellite communication systems to provide connectivity in remote or hard-to-reach locations.

The service system 108 may provide additional services or support for error management and analysis. This could include advanced analytics, machine learning models, or expert systems to assist in diagnosing and correcting complex errors. In some examples, the service system 108 may receive information from the error analysis component 118. The information may include information regarding a root cause of an error, information regarding the error, and debugging data regarding the error. The service system 108 may use the information to determine a corrective action to correct the error and may implement the corrective action. In some implementations, the service system 108 may also provide updates to the error manager 112 or the error database 120 based on new knowledge or patterns discovered across multiple systems.

The computing devices 104 and 106 are connected to the network 110 and may generate errors that are sent to the computing device 102 for processing. These devices could represent various types of systems that are being monitored for errors, such as servers, workstations, mobile devices, or Internet of Things (IoT) devices. In some embodiments, the computing devices 104 and 106 may have their own local error detection and preliminary analysis capabilities before sending error indications to the computing device 102.

As indicated above, FIG. 1 is provided as an example. Other examples may differ from what is described with regard to FIG. 1. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

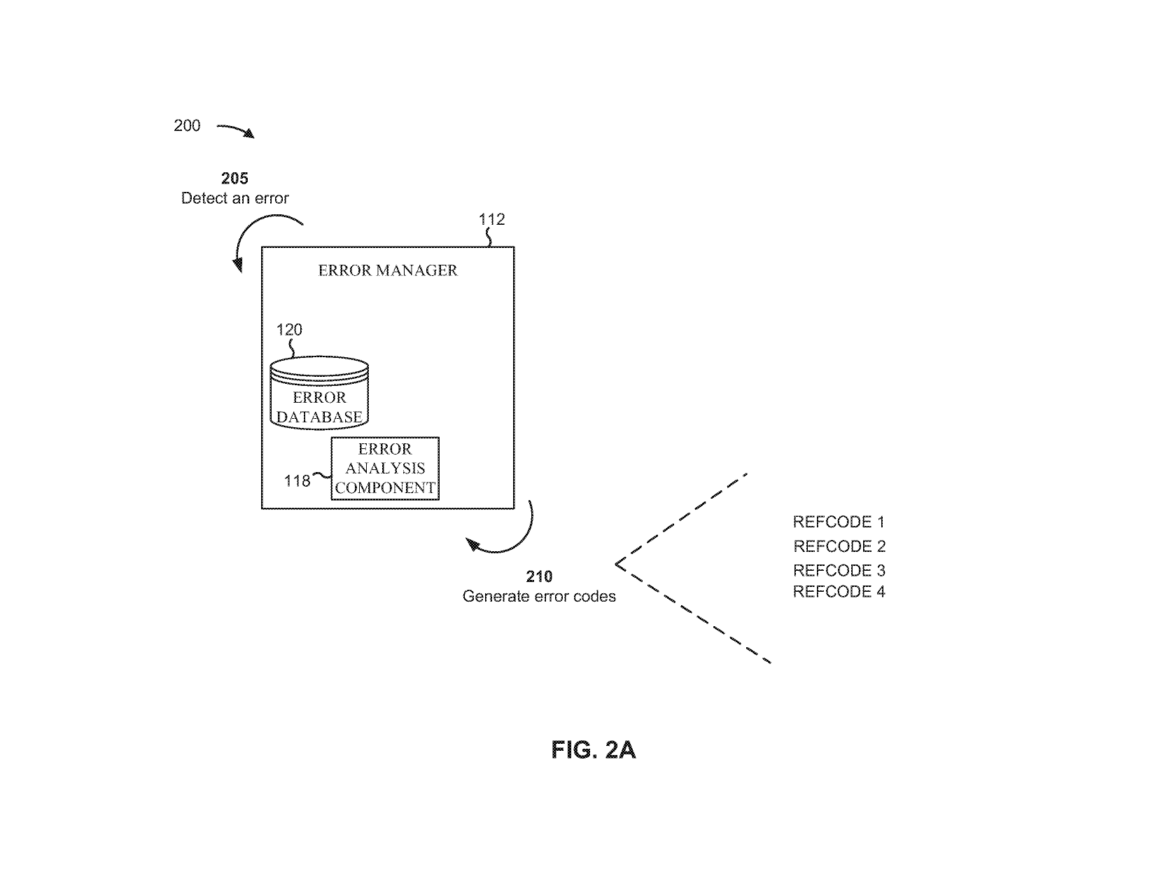

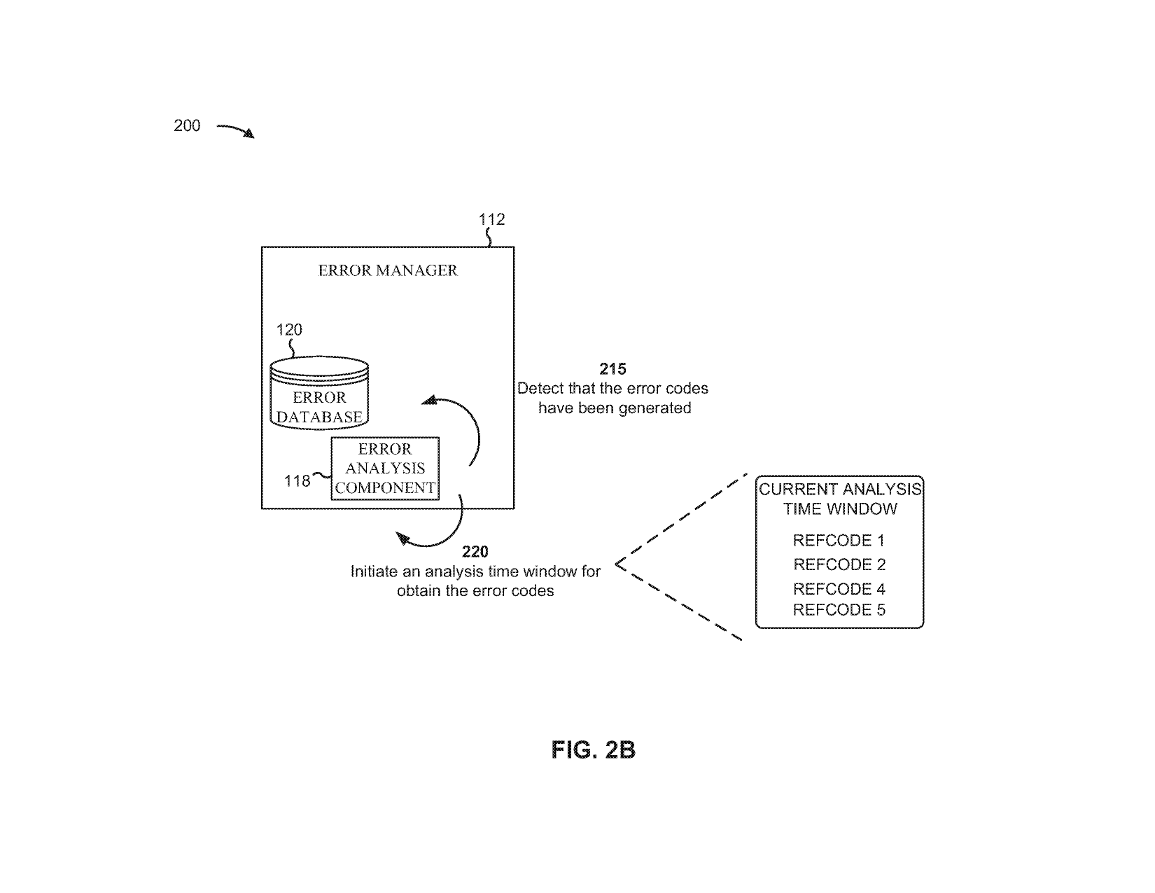

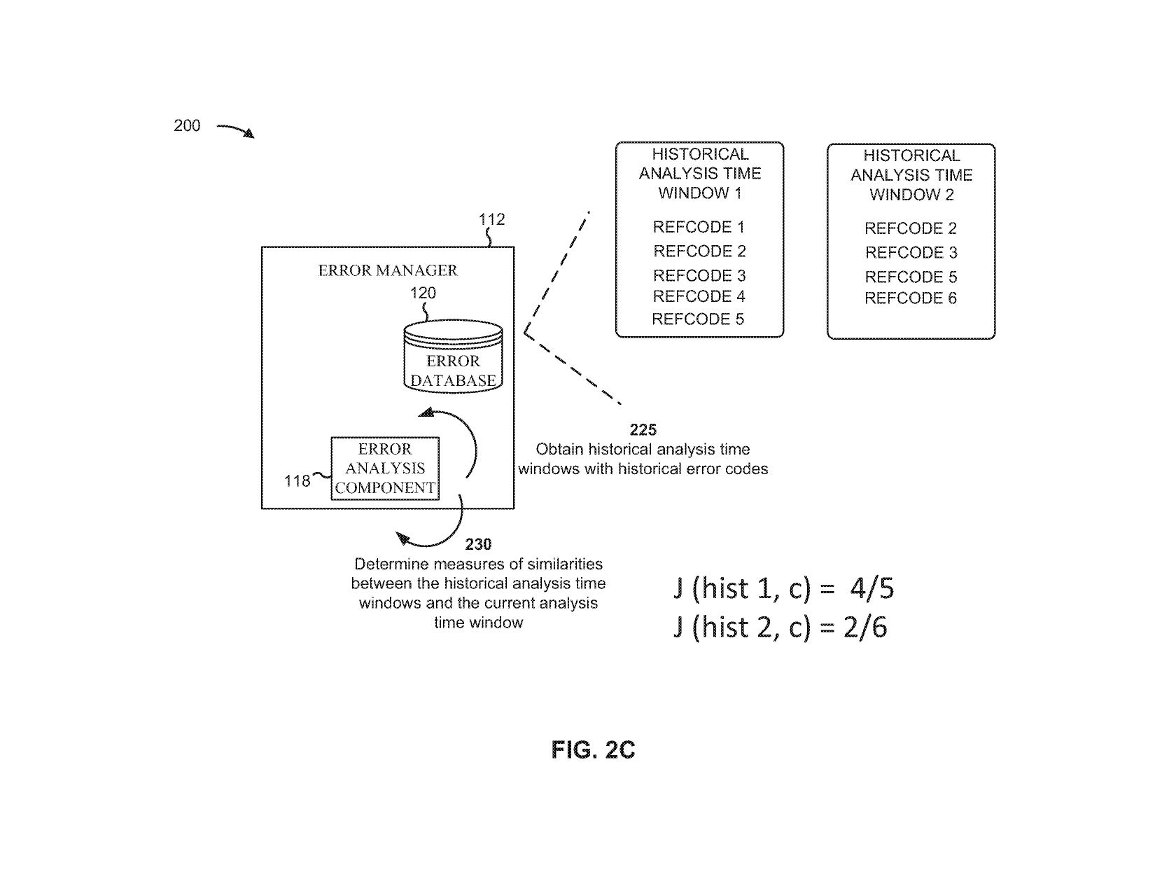

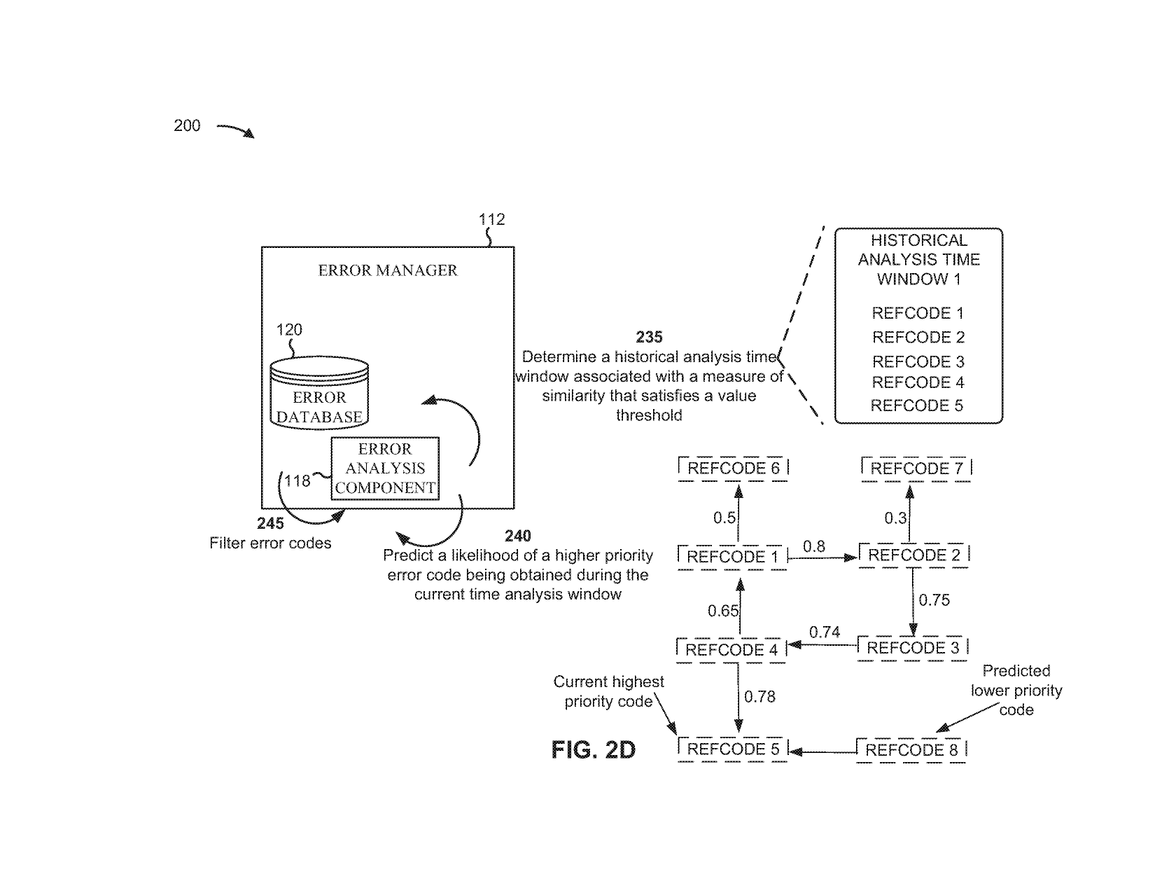

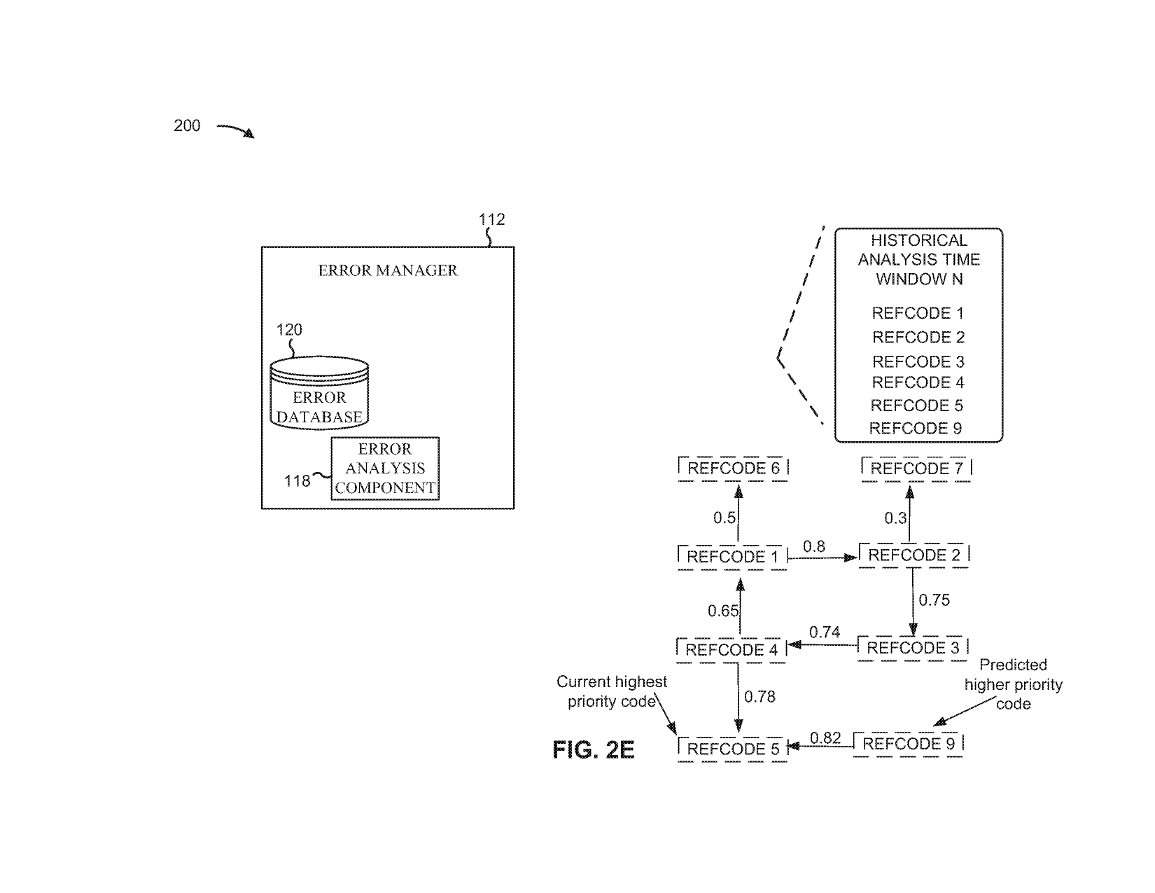

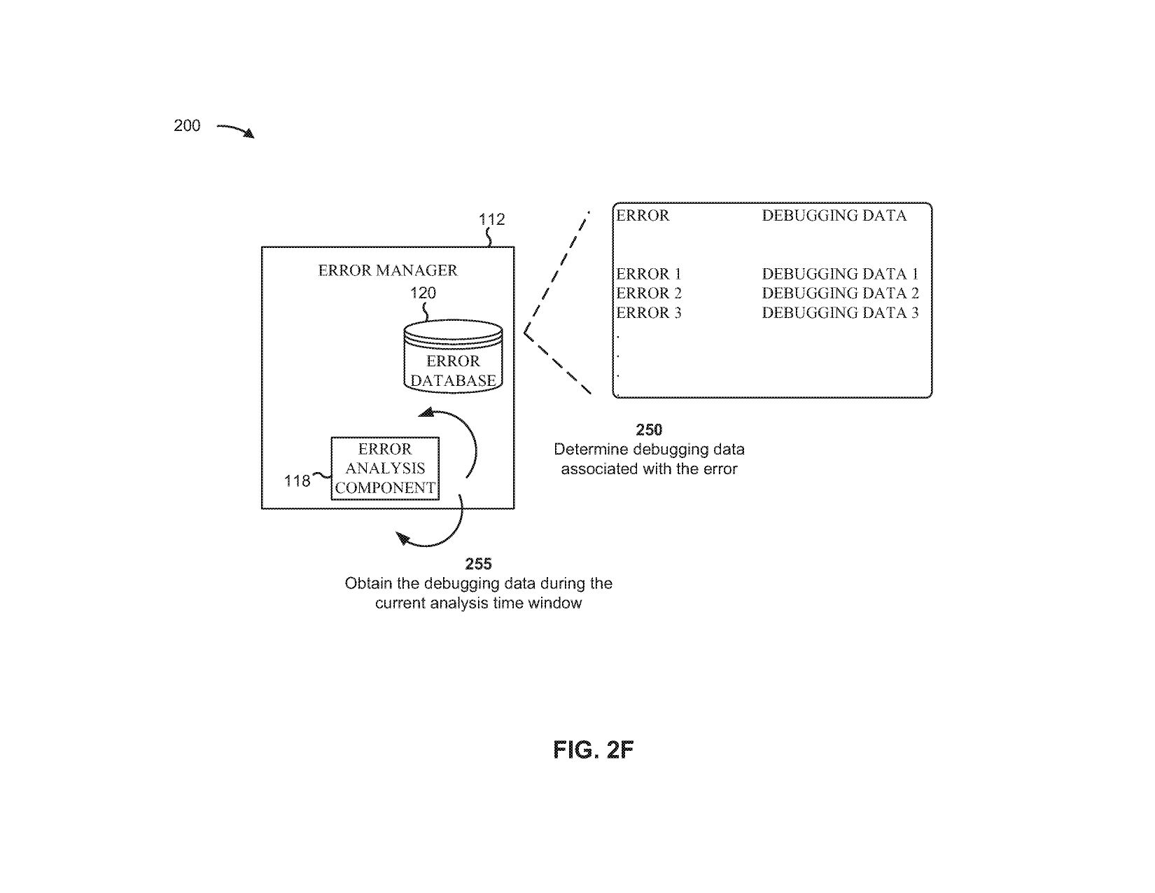

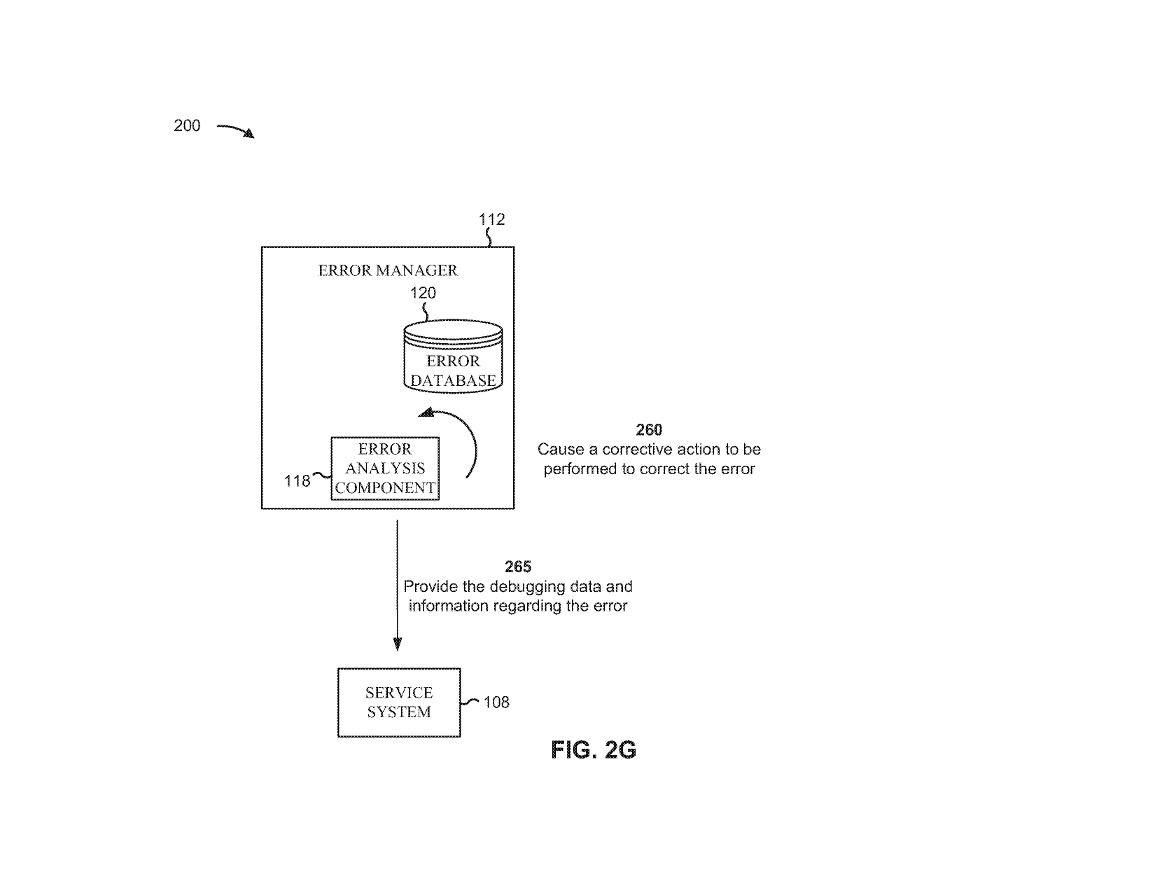

FIGS. 2A-2C are diagrams of an example implementation 200 described herein. As shown in FIGS. 2A-2C, example implementation 200 includes the computing device 102 and the service system 108. As shown in FIG. 2A, and by reference number 205, the error manager 112 may detect an error. For example, error manager 112 may detect an error of a component of the computing device 102. In some examples, error manager 112 may detect the error based on receiving signals from the component and/or from one or more other components that rely on or that are connected to the component.

As shown in FIG. 2A, and by reference number 210, the error manager 112 may generate error codes. For example, error manager 112 may generate the error codes based on detecting the error. As shown in FIG. 2A, the error codes may include REFCODE 1 (e.g., error reference code 1), REFCODE 2 (e.g., error reference code 2), and so on. In some examples, the component may generate an error code. In some examples, the one or more components may generate one or more error codes.

As shown in FIG. 2B, and by reference number 215, error analysis component 118 may detect that the error codes have been generated. For example, error analysis component 118 may start obtaining one or more of the error codes generated by error manager 112, the component, and/or the one or more components.

As shown in FIG. 2B, and by reference number 220, error analysis component 118 may initiate an analysis time window for obtain the error codes. For example, based on obtaining one or more of the error codes, error analysis component 118 may initiate a current analysis time window. Error analysis component 118 may obtain remaining error codes generated by error manager 112, the component, and/or the one or more components. The error codes may form error data. As shown in FIG. 2B, the error codes obtained during the current analysis time window may include REFCODE 1 (e.g., error reference code 1), REFCODE 2 (e.g., error reference code 2), REFCODE 4 (e.g., error reference code 4), and REFCODE 5 (e.g., error reference code 5).

During the current analysis time window, error analysis component 118 may analyze the error data (e.g., the error codes) to determine a root cause of the error. Error analysis component 118 may analyze the error data using one or more techniques described herein. Error analysis component 118 may determine to start obtaining debugging data while performing the analysis of the error data.

As shown in FIG. 2C, and by reference number 225, error analysis component 118 may obtain historical analysis time windows with historical error codes. For example, based on determining to start obtaining the debugging data while performing the analysis of the error data, error analysis component 118 may obtain the historical analysis time windows with the historical error codes from the error database 120. Error analysis component 118 may obtain the historical analysis time windows with the historical error codes to identify a historical analysis time window with historical error data that is similar to the error data.

As shown in FIG. 2C, historical analysis time window 1 may include REFCODE 1 (e.g., error reference code 1), REFCODE 2 (e.g., error reference code 2), REFCODE 3 (e.g., error reference code 3), REFCODE 4 (e.g., error reference code 4), and REFCODE 5 (e.g., error reference code 5). As shown in FIG. 2C, historical analysis time window 2 may include REFCODE 2 (e.g., error reference code 2), REFCODE 3 (e.g., error reference code 3), REFCODE 5 (e.g., error reference code 5), and REFCODE 6 (e.g., error reference code 6).

As shown in FIG. 2C, and by reference number 230, error analysis component 118 may determine measures of similarities between the historical analysis time windows and the current analysis time window. In some implementations, error analysis component 118 may compare the error code data of the current analysis time window and the historical error code data of the historical analysis time windows. For example, error analysis component 118 may compare the error codes and the historical error codes of historical analysis time window 1 to generate a first value, compare the error codes and the historical error codes of historical analysis time window 2 to generate a second value, and so on.

In some implementations, error analysis component 118 may determine the measures of similarities using Jaccard indexes. For example, error analysis component 118 may determine a first Jaccard index the error codes and the historical error codes of historical analysis time window 1, determine a second Jaccard index the error codes and the historical error codes of historical analysis time window 2, and so on.

As shown in FIG. 2C, the first Jaccard index may be determined using a size of the intersection of the error codes and the historical errors codes and using a size of the union of the error codes and the historical errors codes. For example, the first Jaccard index may be determined using a ratio corresponding the size of intersection divided by the size of the union.

As shown in FIG. 2D, and by reference number 235, error analysis component 118 may determine a historical analysis time window associated with a measure of similarity that satisfies a value threshold. For example, error analysis component 118 may identify a historical analysis time window associated with a measure of similarity that satisfies the value threshold. In some examples, the value threshold may include a predetermined value. In some examples, the value threshold may include a value selected by a user associated with the computing device 102. As shown in FIG. 2D, error analysis component 118 may identify (or select) historical analysis time window 1.

As shown in FIG. 2D, and by reference number 240, error analysis component 118 may predict a likelihood of a higher priority error code being obtained during the current time analysis window. For example, error analysis component 118 may analyze the historical analysis time window (identified above) to determine the likelihood of the higher priority error code being obtained during the current time analysis window. For example, error analysis component 118 may analyze the error codes and a sequence (or an order) in which the error codes were obtained and compare the sequence to a sequence (or an order) in which the historical error codes (of the historical analysis time window) were obtained.

Error analysis component 118 may analyze the sequence (or the order) in which the historical error codes were obtained to determine a probability of the higher priority error code being obtained. As shown in FIG. 2D, a current highest priority error code, obtained during the current analysis time window) may be REFCODE 5. In this regard, error analysis component 118 may analyze the sequence (or the order) to determine whether a higher priority error code is to be obtained after the current highest priority error code.

In some examples, error analysis component 118 may apply a Markov chain to the historical error codes of the historical analysis time window. As shown in FIG. 2D, the Markov chain may involve assigning a probability of one error code occurring following another error code. The Markov chain may include a chain of occurrences with probabilities on each edge between two error codes. Based on the historical data regarding previous errors occurring after one another, error analysis component 118 may formulate the probabilities of the next error code (in the current analysis time window) being a higher priority error code.

Error analysis component 118 may calculate the likelihood of occurrence, within the current analysis time window, of a higher priority error code (e.g., a error code with a priority that exceeds a priority assigned to the current highest priority error code). In some examples, error analysis component 118 may compare the order of error codes that have been collected and the order of the historical error codes of the historical analysis time windows. Based on comparing the order of error codes that have been collected and the order of the historical error codes of the historical analysis time windows, error analysis component 118 may determine whether the order of the historical error codes indicate that a higher priority error code was obtained after the current highest priority error code was obtained. As shown in FIG. 1D, the order of the historical error codes may indicate that a higher priority error code was not obtained after the current highest priority error code. Rather, a lower priority code was obtained after the current highest priority error code. If the analysis does not provide an inference of a higher priority error expected to be obtained during the current analysis time window, then error analysis component 118 may collect debugging data for the current highest priority error. As shown in FIG. 1E, the order of the historical error codes may indicate that a higher priority error code was obtained after the current highest priority error code. If the analysis does provide an inference of a higher priority error expected to be obtained during the current analysis time window, then error analysis component 118 may collect debugging data for the higher priority error after the higher priority error code has been obtained.

Referring back to FIG. 2D, and by reference number 245, error analysis component 118 may filter error codes. For example, error analysis component 118 may filter error codes that have previously been falsely identified as root causes for the error (or for a similar error). By filtering the error codes, implementations described herein may preserve time associated with utilizing the error codes, preserve computing resources associated with utilizing the error codes, and preserve storage resources associated with utilizing the error codes. By filtering the error codes, implementations described herein may improve an efficiency correcting the error.

As shown in FIG. 2F, and by reference number 250, error analysis component 118 may determine debugging data associated with the error. For example, error analysis component 118 may determine the debugging data associated with the error indicated by the current highest priority error code if the higher priority error code is not expected to be obtained during the current analysis time window. For example, error analysis component 118 may performing a look up of the data stored (of error database 120) that stores information identifying different errors in association with information identifying different debugging data to be obtained to correct the different errors. Error analysis component 118 may perform the look up using information identifying the error, using the current highest priority error code, among other examples. Error analysis component 118 may determine the debugging data that is to be obtained based on performing the look up. Additionally, or alternatively, error analysis component 118 may determine one or more sources of the debugging data. If the higher priority error code is expected to be obtained during the current analysis time window, error analysis component 118 may obtain the debugging data associated with the error indicated by the higher priority error code, after the higher priority error code has been obtained. Error analysis component 118 may obtain the debugging data in a manner similar to the manner described herein.

As shown in FIG. 2F, and by reference number 255, error analysis component 118 may obtain the debugging data during the current analysis time window. For example, error analysis component 118 may obtain the debugging data from the one or more sources. The one or more sources may include other components of the computing device 102 and/or other computing devices. The debugging data may include files, logs, stack traces, among other examples. The debugging data may identify historical corrective actions performed and measures of success of the corrective actions. In some examples, obtaining the debugging data may include obtain the debugging data from a memory core of the computing device 102. In this regard, error analysis component 118 may cause a core dump of data to be performed.

As shown in FIG. 2G, and by reference number 260, error analysis component 118 may cause the corrective action to be performed to correct the error. In some implementations, error analysis component 118 may determine the corrective action based on analyzing the debugging data. In some examples, error analysis component 118 may perform the corrective action. In some examples, error analysis component 118 may cause one or more components of the computing device 102 to perform the corrective action. In some examples, error analysis component 118 may cause one or more other computing devices to perform the corrective action.

In some examples, if the error is a power disruption or failure, the corrective action may include restoring power. In some examples, if the error is a network disruption or failure, the corrective action may include restoring a network connection. In some examples, if the error is a network disruption or failure, the corrective action may include restoring a network connection. A priority associated with an error code for the power disruption or failure may exceed a priority associated with an error code for the network disruption or failure. In some examples, if the error is a microcode error, the corrective action may include rebooting the computing device 102. A priority associated with an error code for the network disruption or failure may exceed a priority associated with an error code for the microcode error.

As shown in FIG. 2G, and by reference number 265, error analysis component 118 may provide the debugging data and information regarding the error. For example, error analysis component 118 may provide the debugging data, information regarding the high priority error code (if obtained during the current analysis time window), information regarding the current highest error code (if the high priority error code is not obtained during the current analysis time window), information regarding the error, and/or information regarding the corrective action to the service system 108. In some examples, the service system 108 may determine the corrective action based on the debugging data, the information regarding the high priority error, and/or the information regarding the error.

In some implementations, providing the information to the service system 108 may be referred to as a call home operation. A call home operation typically involves packaging information about the system’s current state, recent errors, and diagnostic data into a structured format, such as a log file or telemetry data packet. The information may include error codes, stack traces, performance metrics, and system configuration details. Once packaged, this data may be securely transmitted to a central monitoring service or technical support system (e.g., the service system 108), often using encrypted channels to ensure confidentiality and integrity. Upon receipt, the central service can analyze the data, correlate it with other reports, and initiate appropriate corrective actions, such as sending configuration updates, recommending patches, or dispatching a support technician. By automating this process, call home operations facilitate proactive error management and reduce downtime in distributed environments. In some implementations, a call home operation may include error analysis component 118 executing scripts that will launch data dumps, writing the data dumps to files, and providing the files to the central service.

As indicated above, FIGS. 2A-2F are provided as an example. Other examples may differ from what is described with regard to FIGS. 2A-2F. There may be additional devices (e.g., a large number of devices), fewer devices, different devices, or differently arranged devices than those shown in FIGS. 2A-2F. Furthermore, two or more devices shown in FIGS. 2A-2F may be implemented within a single device, or a single device shown in FIGS. 2A-2F may be implemented as multiple, distributed devices. Additionally, or alternatively, a set of devices (e.g., one or more devices) shown in FIGS. 2A-2F may perform one or more functions described as being performed by another set of devices in FIGS. 2A-2F are.

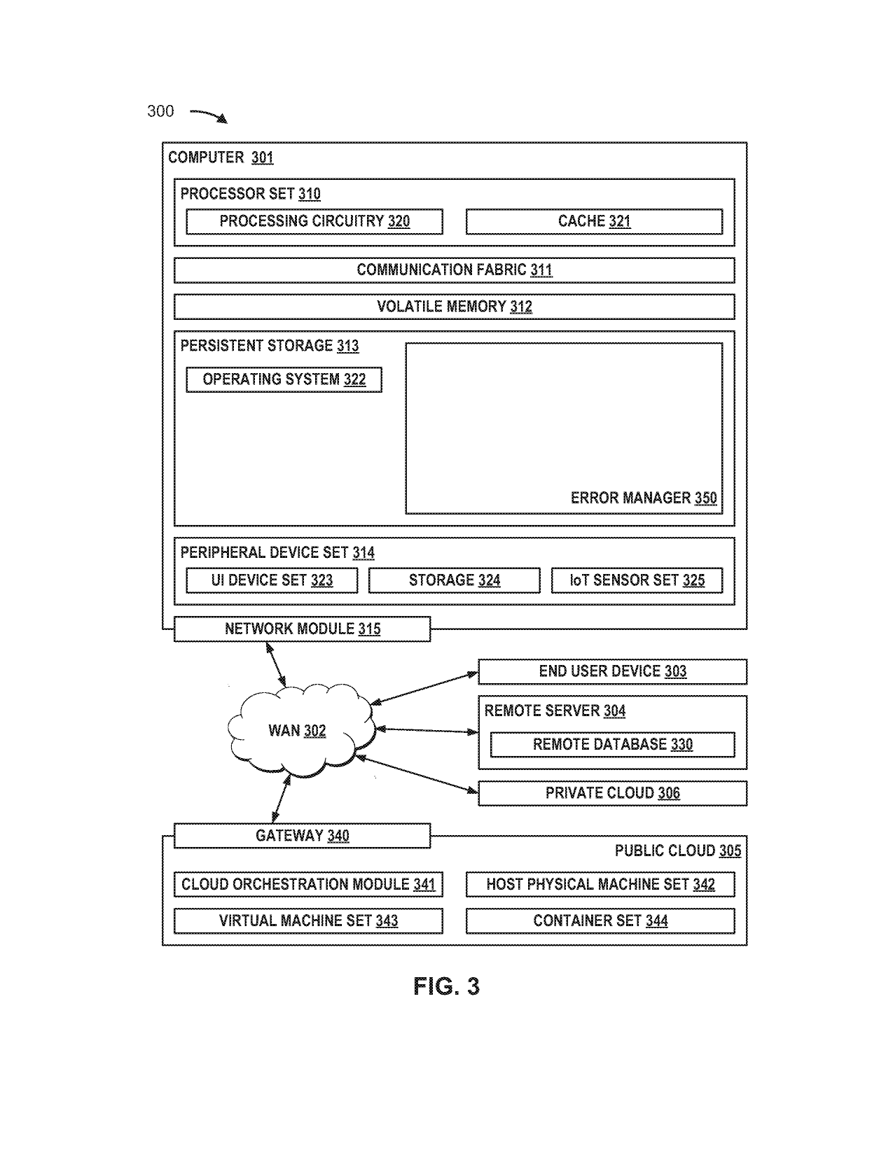

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called "mediums") collectively included in a set of one, or more, storage devices that collectively include machine readable code corresponding to instructions and/or data for performing computer operations specified in a given claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as a load balancer, shown in block 350. In addition to block 350, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

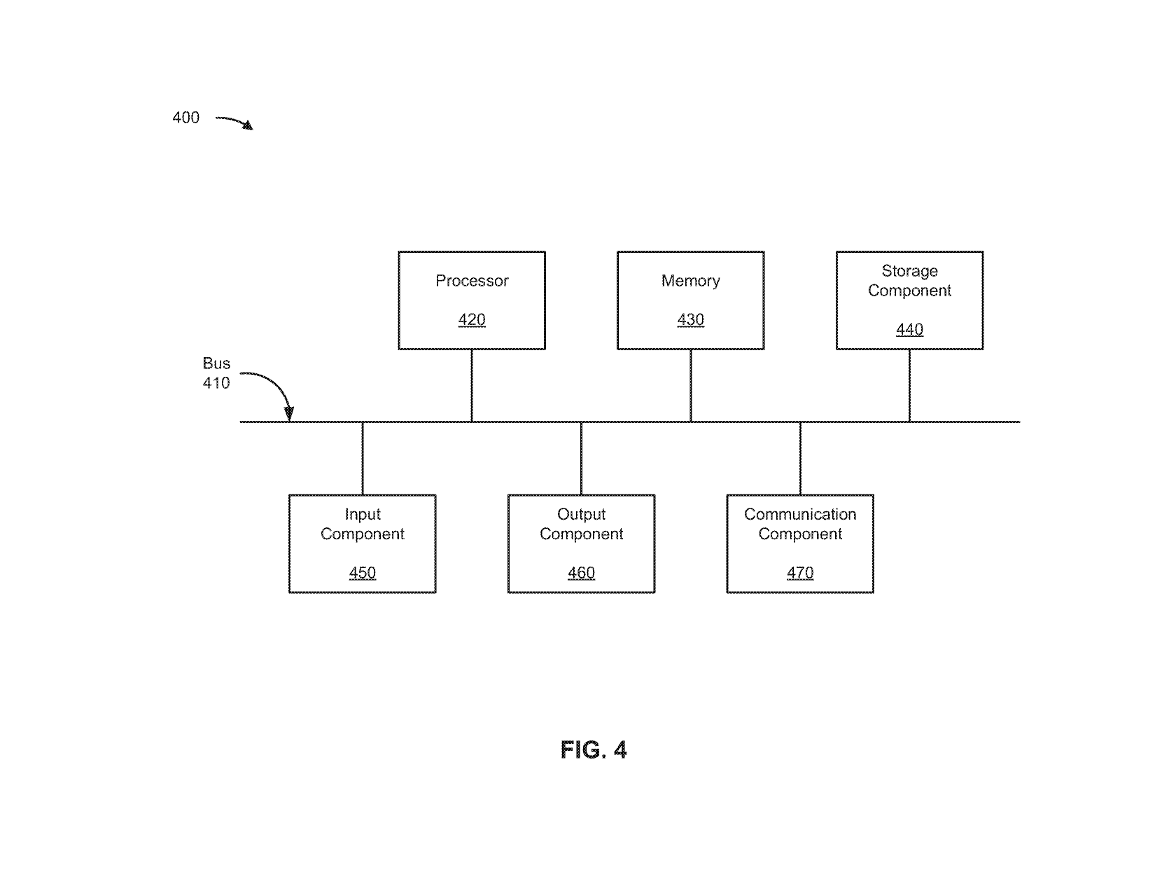

FIG. 4 is a diagram of example components of a device 400, which may implement one or more components of the computing environment 100. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

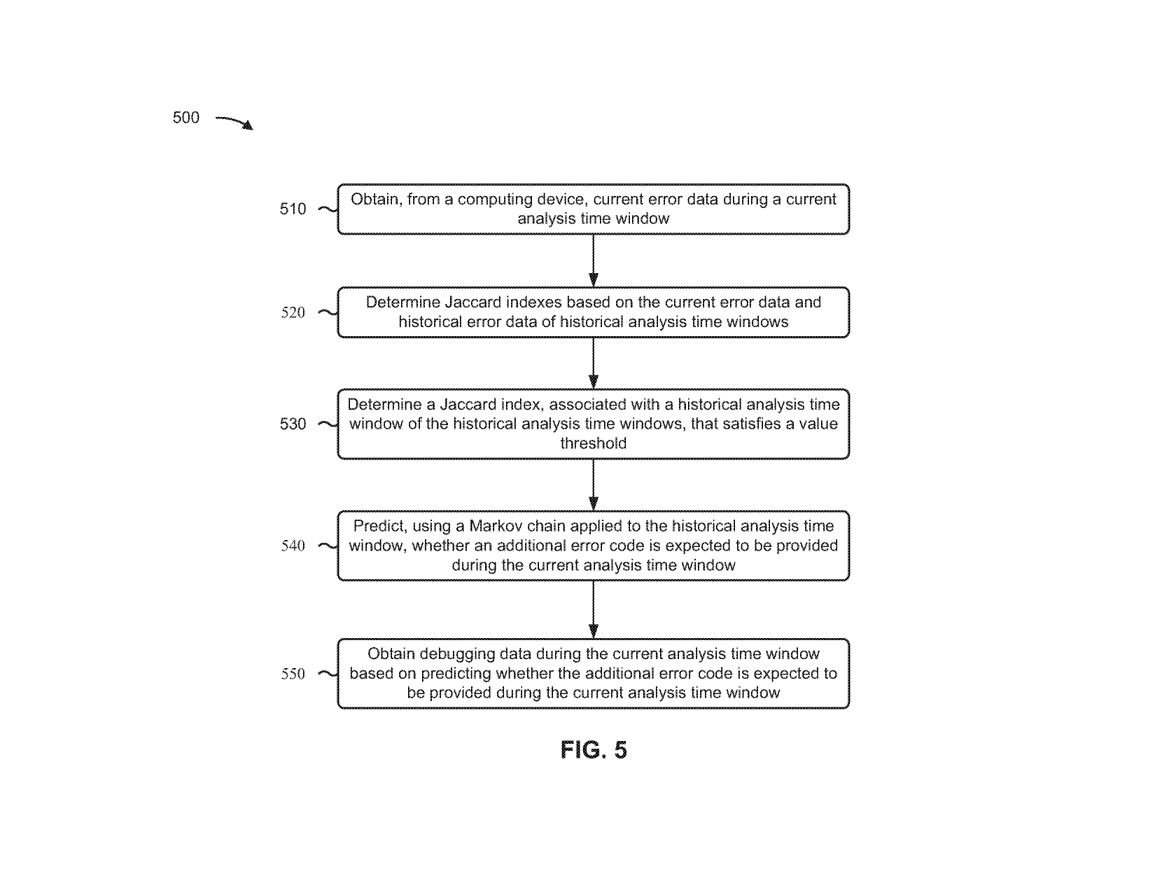

FIG. 5 is a flowchart of an example process 500 associated with obtaining debugging data for correcting a computer error as described herein. In some implementations, one or more process blocks of FIG. 5 may be performed by an error manager (e.g., the error manager 112 or the error analysis component 118). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include obtaining, from a computing device, current error data during a current analysis time window (block 510). For example, the error manager may obtain, from a computing device (e.g., a component of the computing device, current error data during a current analysis time window, as described above. The current error data includes current error codes indicating an error associated with the computing device.

As shown in FIG. 5, process 500 may include determining Jaccard indexes based on the current error data and historical error data of historical analysis time windows (block 520). For example, the error manager may determine Jaccard indexes based on the current error data and historical error data of historical analysis time windows, as described above. The historical error data includes historical error codes. The Jaccard indexes indicates a measure of similarity between the current error data of the current analysis time window and the historical error data of the historical analysis time window.

As shown in FIG. 5, process 500 may include determining a Jaccard index, associated with a historical analysis time window of the historical analysis time windows, that satisfies a value threshold (block 530). For example, the error manager may determine a Jaccard index, associated with a historical analysis time window of the historical analysis time windows, that satisfies a value threshold, as described above.

As shown in FIG. 5, process 500 may include predicting, using a Markov chain applied to the historical analysis time window, whether an additional error code is expected to be provided during the current analysis time window (block 540). For example, the error manager may predict, using a Markov chain applied to the historical analysis time window, whether an additional error code is expected to be provided during the current analysis time window, as described above. The particular error code or one of the current error may be indicative of a root cause of the error. A priority assigned to the additional error code may exceed priorities assigned to the current error codes

As shown in FIG. 5, process 500 may include obtaining debugging data during the current analysis time window based on predicting whether the additional error code is expected to be provided during the current analysis time window (block 550). For example, the error manager may obtain debugging data during the current analysis time window based on predicting whether the additional error code is expected to be provided during the current analysis time window, as described above. The debugging data may include data for correcting the error.

In some implementations, process 500 includes providing the current error data and the debugging data to a service system to cause the service system to correct the error of the computing device.

In some implementations, process 500 includes analyzing the historical error data to identify false positive error codes that have been identified as not being a root cause of the error; and filtering the current error data to remove the false positive error codes from the current error data. A priority assigned to the one of the current error codes exceeds priorities assigned to other ones of the current error codes.

In some implementations, obtaining the debugging data comprises: obtaining the debugging data, associated with the additional error code, after the additional error code has been obtained; or obtaining the debugging data, associated with the one of current error codes, based on based on predicting whether the additional error code is not expected to be provided during the current analysis time window.

In some implementations, the error is associated with a first component of the computing device, and process 500 may include obtaining the debugging data from a second component of the computing device based on the additional error code.

In some implementations, predicting that the additional error code is expected to be provided during the current analysis time window comprises: comparing an order of historical error codes of the historical analysis time window and an order of the error codes of the current analysis time window; and predicting that the additional error code is expected to be based on comparing the order of the historical error codes and the order of the current error codes.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining, from a computing device, current error data during a current analysis time window,
wherein the current error data includes current error codes indicating an error associated with the computing device;
determining Jaccard indexes based on the current error data and historical error data of historical analysis time windows,
wherein the historical error data includes historical error codes,
wherein the Jaccard indexes indicate a measure of similarity between the current error data of the current analysis time window and the historical error data of the historical analysis time windows;
determining a Jaccard index, associated with a historical analysis time window of the historical analysis time windows, that satisfies a value threshold;
predicting, using a Markov chain applied to the historical analysis time window, whether an additional error code is expected to be provided during the current analysis time window,
wherein a priority assigned to the additional error code exceeds priorities assigned to the current error codes; and
obtaining debugging data, associated with the additional error code or one of the current error codes, during the current analysis time window based on predicting whether the additional error code is expected to be provided during the current analysis time window,
wherein the debugging data includes data for correcting the error.

2. The method of claim 1, further comprising:
providing the debugging data to a service system to cause the service system to correct the error of the computing device.

3. The method of claim 1, further comprising:
analyzing the historical error data to identify false positive error codes that have been identified as not being a root cause of the error; and
filtering the current error data to remove the false positive error codes from the current error data.

4. The method of claim 1, wherein obtaining the debugging data comprises:
obtaining the debugging data, associated with the additional error code, after the additional error code has been obtained.

5. The method of claim 1, wherein obtaining the debugging data comprises:
obtaining the debugging data, associated with the one of current error codes, based on based on predicting whether the additional error code is not expected to be provided during the current analysis time window.

6. The method of claim 1, wherein the error is associated with a first component of the computing device, and
wherein the method further comprises:
obtain the debugging data from a second component of the computing device based on the additional error code.

7. The method of claim 5, wherein predicting that the additional error code is expected to be provided during the current analysis time window comprises:
comparing an order of historical error codes of the historical analysis time window and an order of the error codes of the current analysis time window; and
predicting that the additional error code is expected to be based on comparing the order of the historical error codes and the order of the current error codes.

8. The method of claim 1, wherein a priority assigned to the one of the current error codes exceeds priorities assigned to other ones of the current error codes.

9. A computer system comprising:
a storage device; and
a processor set;
one or more computer-readable storage media; and
program instructions stored on the one or more computer-readable storage media to cause the processor set to perform operations comprising:
obtaining current error data during a current analysis time window,
wherein the current error data includes current error codes indicating an error associated with a computing device;
determining measures of similarity between the current error data of the current analysis time window and historical error data of historical analysis time window,
wherein the historical error data includes historical error codes;
determining a measure of similarity, associated with a historical analysis time window of the historical analysis time windows, that satisfies a value threshold;
predicting, based on the historical analysis time window, whether an additional error code is expected to be provided during the current analysis time window;
obtaining debugging data, associated with the additional error code or one of the current error codes, during the current analysis time window based on predicting that the additional error code is expected to be provided during the current analysis time window; and
causing the error of the computing device to be corrected based on the debugging data.

10. The computer system of claim 9, wherein determining the measures of similarity comprises:
determining Jaccard indexes that indicate the measures of similarity.

11. The computer system of claim 9, wherein predicting whether the additional error code is expected to be provided to comprises:
predicting whether the additional error code is expected to be provided using a Markov chain.

12. The computer system of claim 9, wherein a priority assigned to the additional error code exceeds priorities assigned to the current error codes.

13. The computer system of claim 9, wherein the error is associated with a first component of the computing device, and
wherein the operations further comprise:
obtaining the debugging data from a second component of the computing device based on the additional error code.

14. The computer system of claim 9, wherein obtaining the debugging data comprises:
performing a look up of a data store that stores information identifying different errors in association with information identifying different debugging data to be obtained to correct the different errors,
wherein the look up is performed using information identifying the error; and
determining the debugging data that is to be obtained based on performing the look up.

15. A computer program product comprising:
one or more computer-readable storage media; and
program instructions stored on the one or more computer readable storage media to perform operations comprising:
obtaining current error data during a current analysis time window,
wherein the current error data includes current error codes indicating an error associated with a computing device;
determining measures of similarity between the current error data of the current analysis time window and historical error data of historical analysis time window,
wherein the historical error data includes historical error codes;
determining a measure of similarity, associated with a historical analysis time window of the historical analysis time windows, that satisfies a value threshold;
predicting, based on the historical analysis time window, whether an additional error code is expected to be provided during the current analysis time window; and
obtaining debugging data, associated with the additional error code or one of the current error codes, based on predicting whether the additional error code is expected to be provided during the current analysis time window,
wherein the additional error code or the one of the current error codes is indicative a root cause of the error.

16. The computer program product of claim 15, wherein obtaining the debugging data comprises:
performing a look up of a data store that stores information identifying different errors in association with information identifying different debugging data to be obtained to correct the different errors,
wherein the look up is performed using information identifying the error; and
determining the debugging data that is to be obtained based on performing the look up.

17. The computer program product of claim 15, wherein the error is associated with a first component of the computing device, and
wherein the operations further comprise:
obtaining the debugging data from a second component of the computing device based on the additional error code.

18. The computer program product of claim 15, wherein determining the measures of similarity comprises:
determining Jaccard indexes that indicate the measures of similarity.

19. The computer program product of claim 15, wherein predicting whether the additional error code is expected to be provided to comprises:
predicting whether the additional error code is expected to be provided using a Markov chain.

20. The computer program product of claim 15, wherein a priority assigned to the additional error code exceeds priorities assigned to the current error codes.
